(19) United States
(12) Patent Application Publication
(10) Pub. No.: US 2016/0022112 A1
(43) Pub. Date: Jan. 28, 2016

(54) DEBRIS COLLECTION CONTAINER

(71) Applicant: Dudley Davenport, Deerfield Beach, FL (US)

(72) Inventor: Dudley Davenport, Deerfield Beach, FL (US)

(21) Appl. No.: 14/806,569

(22) Filed: Jul. 22, 2015

Related U.S. Application Data
(60) Provisional application No. 62/027,338, filed on Jul. 22, 2014.

(51) Int. Cl. A47L 13/52; A01G 1/12

(52) U.S. Cl. CPC A47L 13/52; A01G 1/12

(57) ABSTRACT

A debris collection container that allows debris to be deposited directly into the debris collection container in a single step. The debris collection container has a detachable lid that doubles as a collection tray. A screen filter is integrated into the collection tray to allow dirt and soil on the debris to be discharged and returned to the ground prior to depositing the debris into the debris collection container. The front edge of the debris collection chamber, and the corresponding edge of the detachable lid has straight edges to facilitate raking debris onto the detachable lid or directly into the debris collection chamber.

### CROSS-REFERENCE TO RELATED APPLICATIONS

This application is related to, and claims the benefit of, the provisional patent application entitled “Debris Collection Container”, filed Jul. 22, 2014, bearing U.S. Ser. No. 62/027,338 and naming Dudley Davenport, the named inventor herein, as sole inventor, the contents of which is specifically incorporated by reference herein in its entirety.

### BACKGROUND OF THE INVENTION

1. Technical Field

The present invention relates to garden tools. In particular, it relates to an improved collection device for garden debris such as, grass cuttings, leafs, twigs, etc.

2. Background

Typically, when lawns or other outdoor areas need to be cleaned as a result of normal debris, such as leaves, twigs, grass cuttings, and/or other small items, the person doing the cleaning will first use a rake or similar device to gather the loose material into a pile. Then, the debris is picked up with a shovel, or by hand, and placed in a leaf bag. Once full, the leaf bag is deposited in a trash container.

This process is time consuming and requires extra work picking up inadvertently dropped debris a second time. It would be desirable to have a single step method of collecting debris that allows an area to be cleaned rapidly and efficiently.

While the various prior art methods accomplish their intended purposes, they also require unnecessary extra work, and take an excessive amount of time to complete their task.

### SUMMARY OF THE INVENTION

The present invention provides a special purpose debris collection container that allows debris to be deposited directly into the debris collection container in a single step. The debris collection container has a detachable lid that doubles as a collection tray. In addition, a screen filter is integrated into the collection tray to allow dirt and soil on the debris to be discharged and returned to the ground prior to depositing the debris into the debris collection container. Both the front edge of the debris collection chamber, and the corresponding edge of the detachable lid have straight edges to facilitate raking debris onto the detachable lid or directly into the debris collection chamber.

### BRIEF DESCRIPTION OF THE DRAWINGS

FIG. 1 is a top perspective view of a preferred embodiment of the debris collection container

FIG. 2 is a top perspective view of the lower storage compartment of the debris collection container.

FIG. 3 is a perspective view of the top surface of the detachable lid of the debris collection container.

FIG. 4 is a perspective view of the bottom surface of the detachable lid of the debris collection container.

FIG. 5 illustrates is a rear view of a preferred embodiment of the lower storage compartment of the debris collection container.

### DESCRIPTION OF THE PREFERRED EMBODIMENT

Prior to a detailed discussion of the figures, a general overview of the invention will be presented. The invention provides a debris collection container 1 that has a detachable lid 3 that doubles as a tray. When used as a tray, the detachable lid 3 is inverted and placed on the ground so that debris such as leafs, twigs, etc., can be raked onto it. When full, the detachable lid 3 is emptied into the lower storage compartment 2 which, when it is full, is then ready for pickup by trash collection services.

An advantage provided by the invention is that in addition to using the detachable lid 3 to pick up debris, the lower storage compartment 2 can be lowered onto its front surface to allow debris to be raked directly into the lower storage compartment 2.

As illustrated in the figures, the front edges of both the lower storage compartment 2 and the detachable lid 3 have straight edges on their front sides 9-10 to facilitate raking debris onto the detachable lid 3 or directly into the lower storage compartment 2.

Also shown on detachable lid 3 are optional dirt/soil collector 5 and optional screen filter 6. When used as a tray, the detachable lid 3 can be giggled when full to enable dirt and soil that was inadvertently raked up with the debris to accumulate in the dirt/soil collector 5. The dirt/soil collector 5 has a screen filter 6 that covers an aperture in the dirt/soil collector 5. When the detachable lid 3 is giggled, the dirt and soil that was inadvertently raked onto the detachable lid 3 falls through the screen filter 6 to the ground. The remaining debris on the detachable lid 3 can then be placed in the lower storage compartment 2.

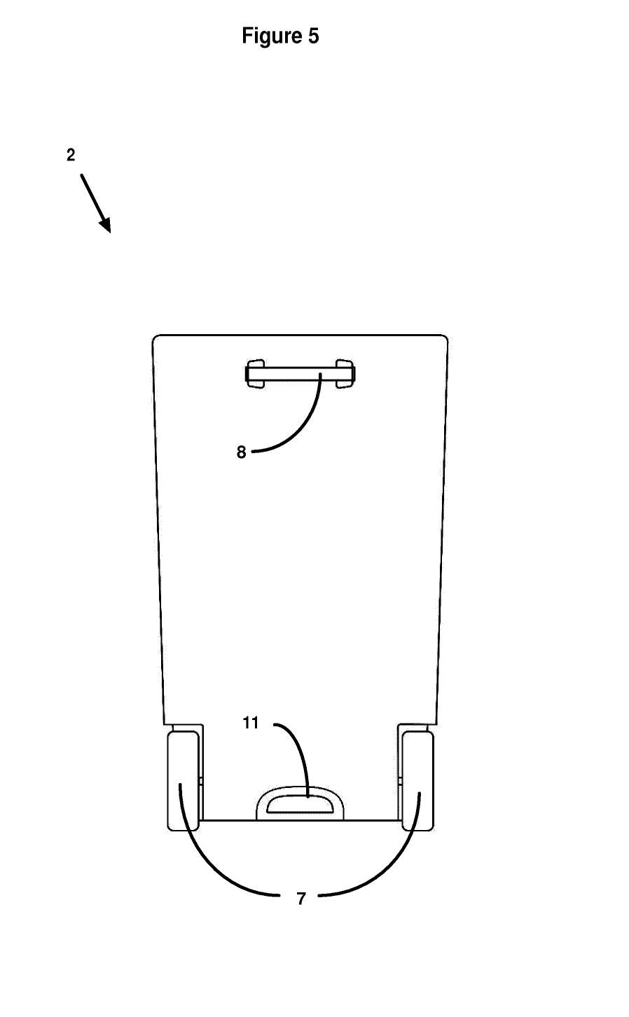

Also shown in this figure is handle 4 that allows the detachable lid 3 to be more easily manipulated, and commonly used wheels 7 (the other wheel 7 is shown in FIG. 5) that allow the debris collection container 1 to be easily moved.

Those skilled in the art will realize that the debris collection container 1 and its constituent parts can be fabricated from any suitable material. However, since the debris collection container 1 will often be stored outdoors or used outdoors, the preferred material should have qualities that are suitable for the outdoor environment it is likely to be used in. For example, plastic, vinyl, polypropylene, etc. are all are highly resistant to weather and other environmental factors, and therefore may be better suited than metal of other materials that may be more susceptible to environmentally caused corrosion.

Having discussed the features and advantages of the invention in general, we turn now to a more detailed discussion of the figures.

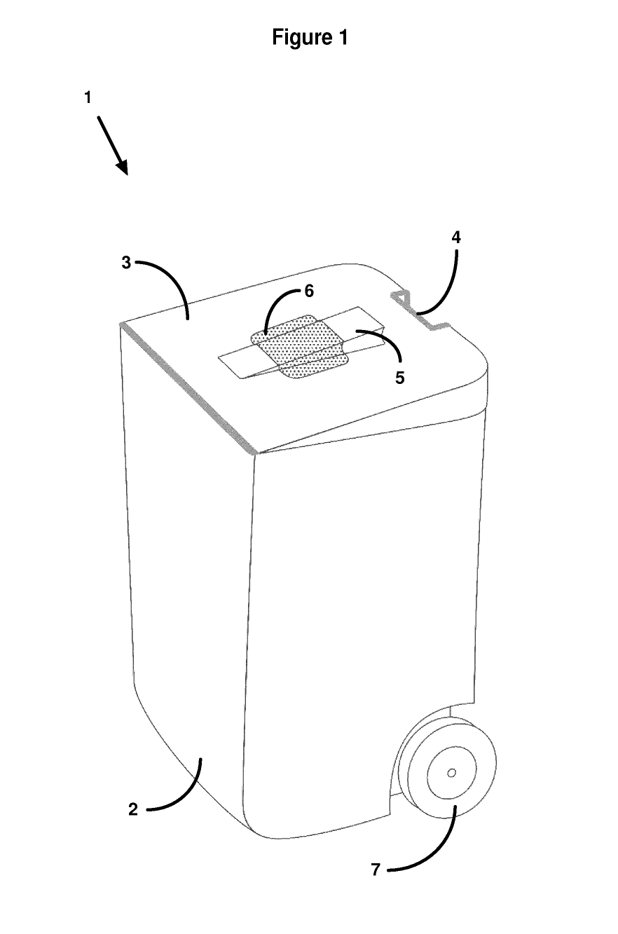

FIG. 1 is a top perspective view of a preferred embodiment of the debris collection container 1. It shows the lower storage compartment 2 and a detachable lid 3 that fits on top of the lower storage compartment 2. In addition, the detachable lid 3 further has a lid handle 4 that facilitates detaching the detachable lid 3 from the lower storage compartment 2.

The detachable lid 3 optionally has an integral dirt/soil collector 5, and an integral screen filter 6. In addition, it also has wheels 7 that facilitate movement of the debris collection container 1.

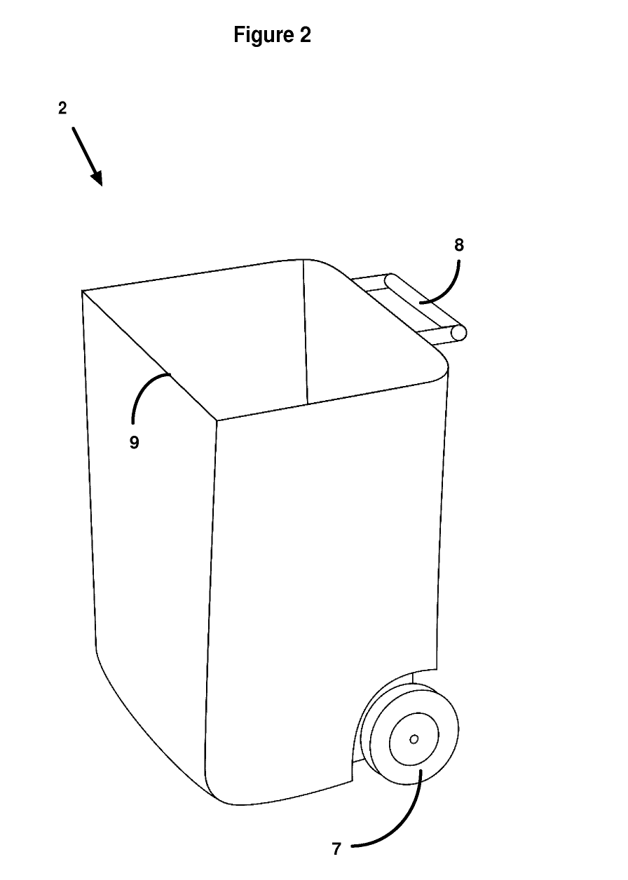

FIG. 2 is a top perspective view of the lower storage compartment 2. In normal use, it is envisioned that the detachable lid 3 would be used to collect the debris. When full, the detachable lid 3 would be used to deposit the debris into the lower storage compartment 2. While the detachable lid 3 is intended to be the primary method of depositing debris into the lower storage compartment 2, there are times when it may, depending on the nature of the debris, be easier to rake debris directly into the lower storage compartment 2. The structure of the debris collection container 1 permits this optional usage. In particular, this figure illustrates the straight, forward edge 9 of the lower storage compartment 2. When the lower storage compartment 2 is laid on the ground, the straight edge 9 facilitates raking debris, such as a leaf pile, directly into the lower storage compartment 2.

This figure also shows lower storage compartment 2 handle 8 that a user would grasp when moving the debris collection container 1.

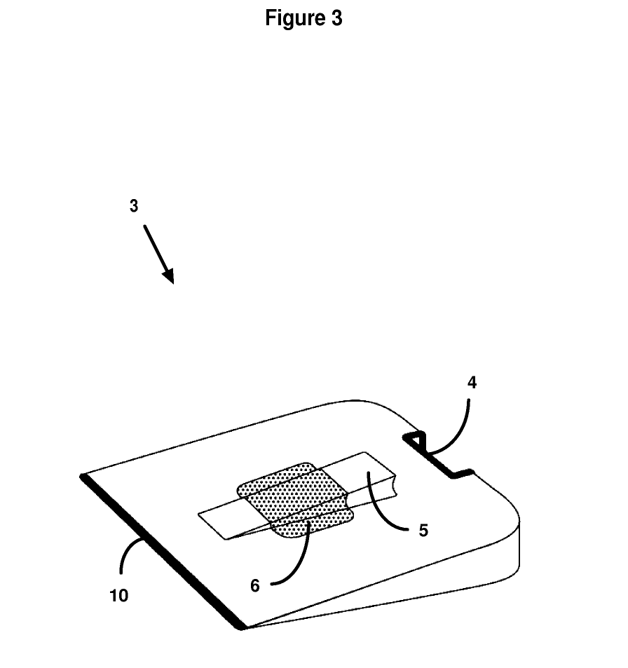

FIG. 3 is a perspective view of the top surface of the detachable lid 3 of the debris collection container 1. This figure illustrates the lid handle 4 that is used to detach the detachable lid 3 from the lower storage compartment 2. The handle 4 can be used to remove the detachable lid 3 by grasping the handle 4 and pulling the detachable lid 3 apart from the lower storage compartment 2. In addition, the handle 4 facilitates an additional advantage provided by the invention. In particular, the user can use the handle 4 to hold the detachable lid 3 in the debris collection position. Further, when using the detachable handle 3, it acts as an extension of the user's arm to increase reach and provides stability when emptying debris into the lower storage compartment 2. Those skilled in the art will recognize that handle 4 can be designed in any suitable shape or configuration for use by an individual.

Integral dirt/soil collector 5 is shown, as well as screen filter 6. In addition to providing a compartment to catch dirt and soil, the dirt/soil collector 5 is also shaped as a sloped wedge to place the straight, forward edge 10 of the detachable lid 3 in closer proximity to the surface of the ground.

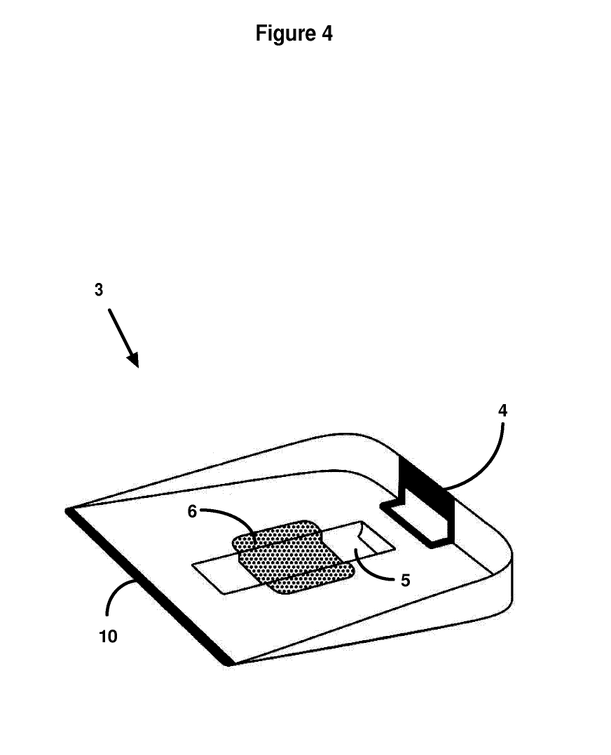

FIG. 4 is a perspective view of the bottom surface of the detachable lid 3 of the debris collection container 1. In the figures, the screen filter 6 is illustrated as being on the top and bottom surfaces of detachable lid 3. However, those skilled in the art will recognize that while this configuration works, it is also possible to place the screen filter 6 only on the top surface or only on the bottom surface of detachable lid 3. It is only necessary that the screen filter 6 allow dirt and soil to fall through it to the ground while the debris is retained within the detachable lid 3.

FIG. 5 illustrates is a rear view of a preferred embodiment of the lower storage compartment 2 of the debris collection container 1. This view shows both wheels 7 and lower storage compartment handle 8. Also shown is optional removable drain plug 11 that allows any water in the lower storage compartment 2 to be drained.

Those skilled in the art will realize that the lower storage compartment 2 handle 8 is for illustrative purposes only, and can be modified to suit various design goals. For example, dual lower storage compartment handles 8 can be positioned in the upper part of the back and the front of the lower storage compartment 2. This provides greater convenience when moving the debris collection container 1. Likewise, the lower storage compartment 8 can be designed such that the detachable lid 3 may be hung from a lower storage compartment handle 8 by the detachable lid handle 4.

The structure of the invention provides the user with several options regarding its use. For example, in regard to debris disposal, the user can insert a plastic leaf bag in the storage container 1. When full, the leaf bag can be removed for disposal pickup apart from the storage container 1. Likewise, the user can leave the debris in the storage container 1 for pickup. Alternatively, the storage container 1 can be used to collect and transport empty loose debris to another preselected location, for example, a composter. Any of these alternative uses can be made with the same storage container 1 depending on the user's preferences.

While the invention has been described with respect to a preferred embodiment thereof, it will be understood by those skilled in the art that various changes in detail may be made therein without departing from the spirit, scope, and teaching of the invention. For example, the material used to construct the device may be anything suitable for its purpose, the handle design can vary, the size and shape can vary, etc. Accordingly, the invention herein disclosed is to be limited only as specified in the following claims.

I claim:

1. A debris collection container, further comprising:
a lower storage compartment; and
a detachable lid, detachably connected to the lower storage compartment, the detachable lid further comprising:
a lid handle; and
at least a portion of the detachable lid having a substantially rimless edge, such that when the detachable lid is placed upside down on the ground, the rimless portion of the detachable lid is substantially adjacent to the surface of the ground;
whereby debris on the ground can be swept or raked over the rimless portion and onto the detachable lid.

2. A container, as in claim 1, wherein;
the rimless portion of the detachable lid has a substantially straight edge.

3. A container, as in claim 2, further comprising;
a handle on the detachable lid substantially opposite the side of the lid with the straight edge.

4. A container, as in claim 3, further comprising;
a dirt/soil collector in the detachable lid for capturing dirt and/or soil unintentionally swept onto the detachable lid.

5. A container, as in claim 4, further comprising;
a screen filter in the dirt/soil collector of the detachable lid, the screen filter sized such that when the detachable lid contains debris and it is shaken, dirt and soil in the debris will fall into the dirt/soil collector and then fall through the screen filter to the ground.

6. A container, as in claim 2, further comprising;
a dirt/soil collector in the detachable lid for capturing dirt or soil unintentionally swept onto the detachable lid.

7. A container, as in claim 6, further comprising;
a screen filter in the dirt/soil collector of the detachable lid, the screen filter sized such that when the detachable lid contains debris and it is shaken, dirt and soil in the debris will fall into the dirt/soil collector and then fall through the screen filter to the ground.

8. A container, as in claim 1, further comprising;
a dirt/soil collector in the detachable lid for capturing dirt or soil unintentionally swept onto the detachable lid.

9. A container, as in claim 8, further comprising;
a screen filter in the dirt/soil collector of the detachable lid, the screen filter sized such that when the detachable lid contains debris and it is shaken, dirt and soil in the debris will fall into the dirt/soil collector and then fall through the screen filter to the ground.

10. A container, as in claim 1, wherein;
at least a portion of the lower storage compartment has a substantially straight edge.

11. a container, as in claim 10, further comprising;
a storage compartment handle.

12. A container, as in claim 10, wherein;
the rimless portion of the detachable lid has a substantially straight edge.

13. A container, as in claim 12, further comprising;
a handle on the detachable lid substantially opposite the side of the lid with the straight edge.

14. A container, as in claim 13, further comprising;
a dirt/soil collector in the detachable lid for capturing dirt and/or soil unintentionally swept onto the detachable lid.

15. A container, as in claim 14, further comprising;
a screen filter in the dirt/soil collector of the detachable lid, the screen filter sized such that when the detachable lid contains debris and it is shaken, dirt and soil in the debris will fall into the dirt/soil collector and then fall through the screen filter to the ground.

16. A container, as in claim 12, further comprising;
a dirt/soil collector in the detachable lid for capturing dirt or soil unintentionally swept onto the detachable lid.

17. A container, as in claim 16, further comprising;
a screen filter in the dirt/soil collector of the detachable lid, the screen filter sized such that when the detachable lid contains debris and it is shaken, dirt and soil in the debris will fall into the dirt/soil collector and then fall through the screen filter to the ground.

18. A container, as in claim 10, further comprising;
a dirt/soil collector in the detachable lid for capturing dirt or soil unintentionally swept onto the detachable lid.

19. A container, as in claim 18, further comprising;
a screen filter in the dirt/soil collector of the detachable lid, the screen filter sized such that when the detachable lid contains debris and it is shaken, dirt and soil in the debris will fall into the dirt/soil collector and then fall through the screen filter to the ground.

20. A container, as in claim 19, further comprising;
a drain plug near the bottom of the lower storage compartment.
